(19) United States
(12) Patent Application Publication
(10) Pub. No.: US 2011/0271044 A1
(43) Pub. Date: Nov. 3, 2011

(54) MEMORY CARD HAVING ONE OR MORE SECURE ELEMENTS ACCESSED WITH HIDDEN COMMANDS

(75) Inventors: Siva G. Narendra, Portland, OR (US); Prabhakar Tadepalli, Bangalore (IN); Thomas N. Spitzer, Portland, OR (US)

(73) Assignee: TYFONE, INC., Portland, OR (US)

(21) Appl. No.: 13/104,962

(22) Filed: May 10, 2011

Related U.S. Application Data
(63) Continuation-in-part of application No. 11/895,629, filed on Aug. 24, 2007.
(60) Provisional application No. 60/920,932, filed on Mar. 30, 2007.

(51) Int. Cl. G06F 12/14

(52) U.S. Cl. 711/103; 711/E12.093

(57) ABSTRACT

A memory card compatible token includes one or more secure elements accessed using secure element commands hidden in a memory card access command. A mobile computing device such as a mobile phone accesses the non-memory components by including a hidden command value as part of the memory card access command. Any set or subset of all possible secure element commands may be routed to one or more secure elements based on the hidden command value.

### RELATED APPLICATIONS

This application is a Continuation in Part (CIP) of U.S. Application Ser. No. 11/895,629, entitled “Memory Card Hidden Command Protocol” by Narendra et al., filed Aug. 24, 2007, which claims priority to U.S. Provisional Application Ser. No. 60/920,932, entitled “Memory Card Hidden Command Protocol” by Narendra et al., filed Mar. 30, 2007, both of which are incorporated herein by reference in their entirety for all purposes.

### FIELD

The present invention relates generally to communications protocols, and more specifically to communications protocols between mobile computing devices and add-on cards.

### BACKGROUND

Many mobile computing devices (such as mobile phones) have memory card slots to accept memory cards. Communication protocols between memory cards and mobile computing devices typically include standardized memory card access commands. Standardization increases interoperability between various types and brands of mobile computing devices and memory cards.

### BRIEF DESCRIPTION OF THE DRAWINGS

FIG. 1 shows a mobile computing device and a token compatible with a memory card slot;

FIG. 2 shows a block diagram of a mobile computing device;

FIGS. 3 and 4 show block diagrams of tokens that communicate with memory card slots in mobile computing devices;

FIG. 5 shows a data portion of a memory card write command;

FIGS. 6-11 show flowcharts of methods in accordance with various embodiments of the present invention;

FIGS. 12-14 show block diagrams of tokens with secure elements that are accessed using hidden commands;

FIG. 15 shows a portion of a memory card access command in accordance with various embodiments of the present invention;

FIG. 16 shows a logical diagram of a command routing component;

FIGS. 17-19 show block diagrams of tokens with secure elements that are accessed using hidden commands; and

FIG. 20 shows an adapter that preserves hidden commands during a translation from a non-memory card interface to a memory card interface.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

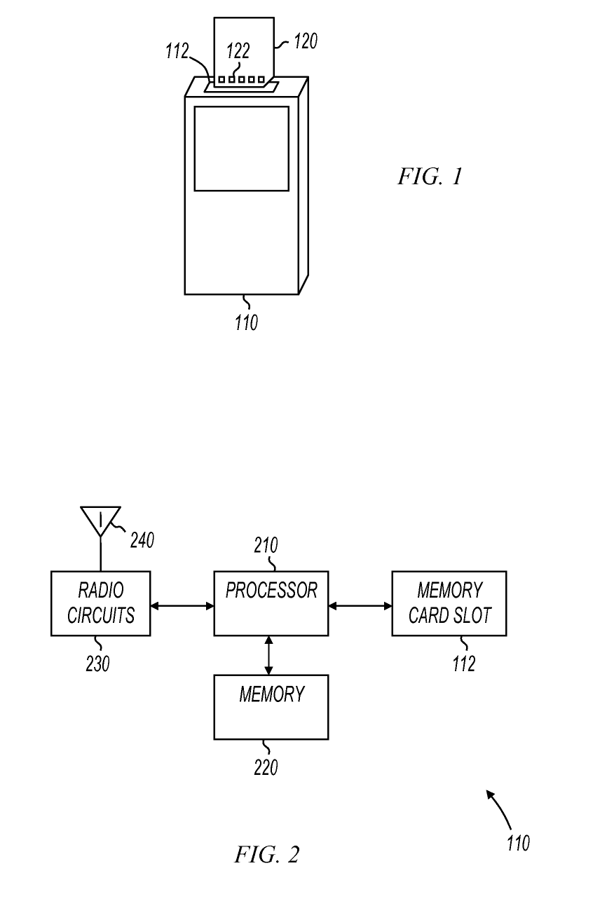

FIG. 1 shows a mobile computing device and a token compatible with a memory card slot. Mobile computing device 110 is shown as a mobile phone in FIG. 1, but this is not a limitation of the present invention. For example, mobile computing device 110 may be a personal digital assistant (PDA), a smartphone, a mobile phone, a handheld computer, a desktop computer, or any other device capable of operating as described herein.

Mobile computing device 110 includes memory card slot 112. Memory card slot 112 is a slot capable of accepting token 120. For example, memory card slot 112 may have physical dimensions compatible with token 120, and may have a communications interface that operates using a protocol compatible with token 120. In some embodiments of the present invention, memory card slot 112 is a memory card slot designed to accept and communicate with memory cards. As used herein, the term “memory card slot” refers to any add-on slot capable of accepting a card having memory accessible by a mobile computing device such as that shown in FIG. 1. For example, a memory card slot may be compatible with an industry standard communications protocol, or may be compatible with a widely accepted communications protocol that is not necessarily formally documented as an industry standard. Examples include slots that are compatible with the Multimedia Memory Card (MMC) protocol, Memory Stick DUO protocol, secure digital (SD) protocol, and Smart Media protocol. In some embodiments, memory card slot 112 is a microSD memory card slot. The foregoing list is meant to be exemplary, and not exhaustive. Memory card slot 112 may be compatible with many memory card slot protocols other than those explicitly listed above without departing from the scope of the invention.

Token 120 includes electrical contacts 122 as part of a host interface that communicates with memory card slot 112. For example, electrical contacts 122 may provide connectivity compliant with a communications protocol for memory cards. In some embodiments, token 120 includes a “contactless” interface to communicate with memory card slot 112. For example, electronic token 120 may include an interface to memory card slot 112 that communicates using electric or magnetic fields, infrared (IR) light, or any other suitable communications mechanism.

Token 120 may include memory and may also include additional functionality. In some embodiments, token 120 includes memory accessible by mobile computing device 110 and also includes additional functionality. In other embodiments, token 120 does not include memory accessible by mobile computing device 110. The additional functionality of token 120 may take any form and the various embodiments of the present invention are not limited in this regard.

In various embodiments of the present invention, the additional functionality in token 120 is accessed by mobile computing device 110 using memory card access commands already defined for use in memory card slot 112. Accordingly, the various embodiments of the present invention enable the implementation of token functions beyond memory accesses without defining new commands. In some embodiments, new commands for the token are embedded inside the data bits subsequent to memory card read/write commands. Token 120 then decides if the incoming data bits are meant for regular read/write functions or for the new functions. In other words, additional token functions may be accessed through commands “hidden” in the data stream that can be exchanged using existing memory card access commands and functions. According to the various embodiments of the invention, both existing memory card functions and new functions may be implemented without requiring changes in how the host protocol is built.

Token 120 (and all other tokens described herein) may take on any form factor without departing from the present invention. For example, in some embodiments, token 120 is a microSD memory card with additional functions.

FIG. 2 shows a block diagram of a mobile computing device. Mobile computing device 110 includes antenna 240, radio circuits 230, processor 210, memory 220, and memory card slot 112. In some embodiments, mobile computing device 110 is a mobile phone, or includes mobile phone functionality. For example, antenna 240 and radio circuits 230 may be utilized to communicate with a cellular telephone network. Further, in some embodiments, mobile computing device 110 is a wireless local area network (WLAN) or wireless wide area network (WWAN) device. For example, antenna 240 and radio circuits 230 may be utilized to communicate with a wireless access point. In some embodiments, antenna 240 and radio circuits 230 are omitted, and mobile computing device 110 does not utilize wireless connectivity.

Processor 210 represents a processor capable of communicating with the other blocks shown in mobile computing device 110. For example, processor 210 may be a microprocessor, a digital signal processor (DSP), a microcontroller, or the like. Further, processor 210 may be formed from state machines or other sequential logic. In operation, processor 210 may read instructions from memory 220 and perform actions in response thereto. For example, processor 210 may execute program instructions that influence communications between mobile computing device 110 and a device coupled to memory card slot 112.

Memory card slot 112 is described above with reference to FIG. 1. Memory card slot 112 includes circuitry compatible with token 120. Mobile computing device 110 may communicate with token 120 by using a standard set of memory card access commands. For example, processor 210 may use memory card write commands to write to memory in token 120, and may use memory card read commands to read from memory in token 120.

The term “memory card access command” as used herein refers to a combination of information useful to access a memory card. For example, a memory card access command may include information that specifies 1) a type of request, such as read or write, 2) an associated location of memory, such as address or sector address, and 3) an associated payload, such as data values that are to be read or written. Accordingly, a “memory card write command” may be a command that indicates the need for a write, an address value specifying where to write, and the data values that need to be written. Further, a “memory card read command” may be a command that indicates the need for a read, an address value of where to read from, and the data values that are read.

Mobile computing device 110 may access additional functionality in token 120 using “hidden” commands embedded in memory card access commands. For example, a memory card write command may include a unique data string to identify the memory card write command as a command to be diverted for purposes other than a memory write. In addition, the sector address provided with the memory card write command may be set to a particular address value to further identify the memory card write command as a command to be diverted. In addition to specific address/data values to identify the memory card access command as a command to be diverted for a purpose other than a memory access, the memory access command may include data bits to further specify the type and function of hidden command. Example formats of hidden commands are described further below. In some embodiments, a read command is issued right after a write command to enable data flow from the non-memory card functions to the host, where the write command's data had the hidden commands. The combination of a memory card write command and a memory card read command can be used in this manner to form a hidden read command.

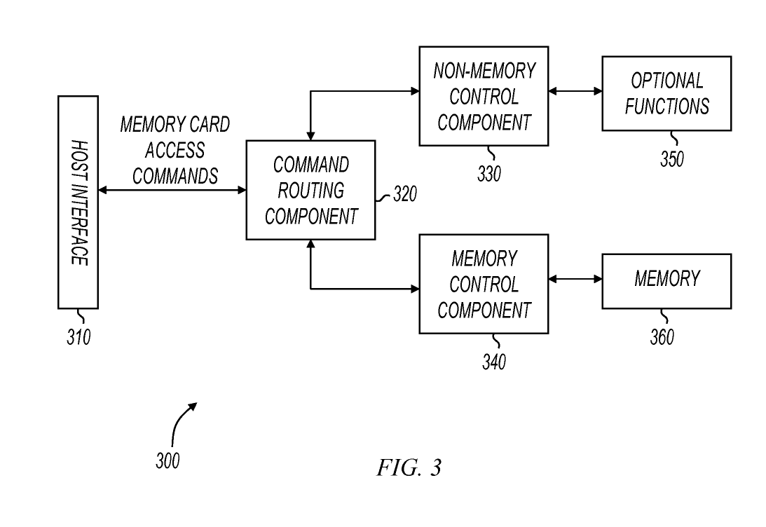

FIG. 3 shows a block diagram of a token that communicates with a memory card slot in a mobile computing device. Token 300 includes host interface 310, command routing component 320, memory control component 340, non-memory control component 330, memory 360, and optional functions 350. Token 300 may be any type of token capable of communicating with a memory card slot in a mobile computing device. Further, token 300 may take any form factor compatible with a memory card slot.

Memory 360 may be any type of volatile or non-volatile memory. For example, memory 360 may be volatile memory such as static random access memory (SRAM) or dynamic random access memory (DRAM). Also for example, memory 360 may be nonvolatile memory such as NOR FLASH memory or NAND FLASH memory. In various embodiments of the present invention, memory 360 represents memory that is accessed by a mobile computing device using memory card access commands defined for that purpose.

Optional functions 350 may include any function that can be added to token 300. As described further below, optional functions 350 may be accessed by a mobile computing device by sending hidden commands within a memory card access command.

Host interface 310 includes electrical contacts to interface with a memory card slot. For example, in some embodiments, host interface 310 includes contacts such as contacts 122 (FIG. 1). Also for example, in some embodiments, host interface 310 includes recessed electrical contacts. Host interface 310 may also include circuitry such as drivers, receivers, terminations, and the like.

Command routing component 320 functions to route memory card access commands received from host interface 310. Commands may be routed to memory control component 340 for memory accesses, or may be routed (diverted) to non-memory control component 330 for purposes other than memory accesses. For example, when token 300 is communicating with a memory card slot in a mobile computing device, the mobile computing device may send a memory card access command in order to access memory 360. Also for example, the mobile computing device may send a memory card access command that contains a hidden command. Command routing component 320 detects the presence of the hidden command, and diverts all or a portion of the memory access command to non-memory control component 330.

Command routing component 320 can detect the hidden command in many ways. For example, in some embodiments, the memory card access command may include a specific address value or a specific data value. Command routing component 320 detects commands that include one or both of the specific address value or specific data value and routes the command appropriately. The specific address value and specific data value used for this purpose are referred to herein as the hidden command address value and the hidden command data value. Further, the term “hidden command value” is used herein to refer to either of, or the combination of, the hidden command address value and the hidden command data value.

In some embodiments, command routing component 320 diverts commands based only on the hidden command address value. In these embodiments, command routing component 320 checks the address value included in memory card access command, and diverts the command if it matches the hidden command address value. In some embodiments, command routing component 320 diverts commands based only on the hidden command data value. In these embodiments, command routing component 320 checks a data value included in the memory card access command, and diverts the command if it matches the hidden command data value. In still further embodiments, command routing component 320 diverts commands based on both the hidden command address value and the hidden command data value. In these embodiments, command routing component 320 diverts the command only if both the memory card access address and data match the hidden command address value and data value, respectively.

The hidden command address value and hidden command data value may be specified in many ways. For example, all tokens may be issued with fixed values that are common to all tokens. In these embodiments, each time the optional functions are accessed, the same hidden command address and/or data value is included in the memory card access command. Also for example, different tokens may be issued with unique values. In these embodiments, each token may provide these values to a mobile computing device when queried. Also for example, hidden command address and/or data values may be specified by the mobile computing device or by a third party over a network. In still further embodiments, hidden command address and data values may be dynamic. The hidden command address and data values may change each time power is applied or on a periodic basis.

In some embodiments, a fixed hidden command value may be common to all tokens, and all tokens may allow a subset of all possible hidden commands when a common hidden command value is recognized. For example, all tokens may allow simple queries such as a request for a chip serial number (CSN) using a common hidden command value. Also for example, all tokens may block access to more sensitive information (such as financial information stored in the token) when a common hidden command value is recognized.

In some embodiments, one or more unique hidden command values are recognized by individual tokens, and different subsets of all possible hidden commands are allowed for each of the unique hidden command values. Command routing component 320 may recognize any number of common, unique, and/or dynamic hidden command values, and may allow any number of subsets of all possible hidden commands based on these hidden command values. In some embodiments, dynamic hidden command values “roll” to different values each time they are used.

In various embodiments of the invention, command routing component 320, memory control component 340, and non-memory control component are implemented in many different ways. For example, in some embodiments, the various components are implemented in hardware. In these embodiments, the various components may be implemented as separate integrated circuits, or in a combined integrated circuit. Also for example, in some embodiments, the various components may be implemented in software, or in a combination of hardware and software. In some embodiments, token 300 may include a microprocessor, and the components may be implemented as software modules running on the microprocessor. In other embodiments, token 300 may includes multiple processors, and the components may be implemented as software modules distributed across the multiple processors.

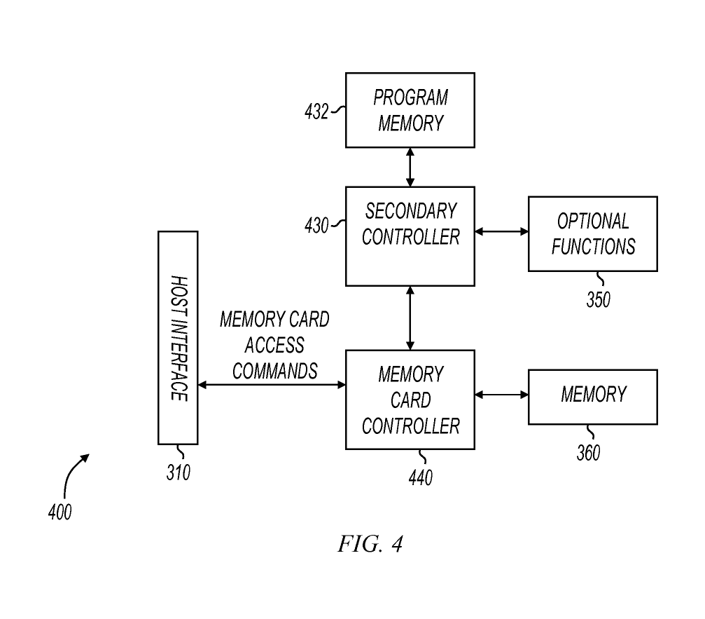

FIG. 4 shows a token in accordance with various embodiments of the present invention. Token 400 includes host interface 310, memory card controller 440, memory 360, secondary controller 430, program memory 432, and optional functions 350. Host interface 310, memory 360, and optional functions 350 are described above with reference to FIG. 3.

In embodiments represented by FIG. 4, memory card controller 440 communicates with the mobile device using memory card access commands. Memory card controller 440 also communicates with memory 360. Memory card controller 440 determines whether each command should result in a memory operation with memory 360, or whether the command should be diverted to secondary controller 430. In some embodiments, memory card controller 440 executes instructions that are stored in an internal memory or stored in memory 360. In some embodiments, memory card controller 440 includes special purpose hardware useful to determine whether a command should be diverted. In other embodiments, memory card controller 440 may be a microcontroller identical in all respects to a controller found in memory cards, except for the program that it executes.

Secondary controller 430 receives hidden commands diverted by memory card controller 440. Secondary controller 430 further interprets the hidden commands and performs actions in response thereto. For example, secondary controller 430 may command optional functions 350 to provide a service. Secondary controller 430 executes instructions stored in program memory 432. In some embodiments, program memory 432 is embedded in secondary controller 430, and in other embodiments, program memory 432 is part of memory 360.

In embodiments represented by FIG. 4, memory card controller 440 includes the functionality of both command routing component 320 and memory control component 340 (FIG. 3), and secondary controller 430 includes the functionality of non-memory control component 330 (FIG. 3). In other embodiments, secondary controller 430 communicates with host interface 310 and memory card controller 440, and includes the functionality of the command routing component.

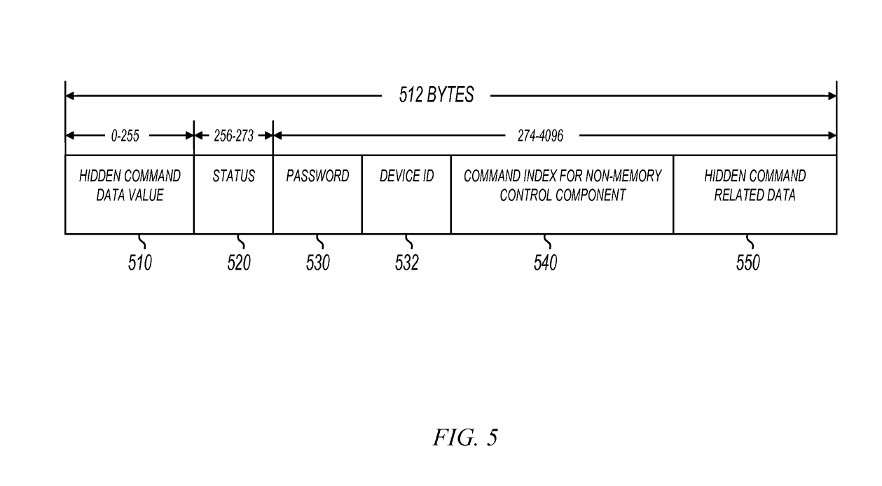

FIG. 5 shows a data portion of a memory card write command. Included are hidden command data value 510, status field 520, password field 530, device ID 532, command index 540, and hidden command related data 550. In the example of FIG. 5, the data portion is 512 bytes in length, although this is not a limitation of the present invention. Any amount of data may be included in the write command, and each field shown in FIG. 5 may be any length.

In the example of FIG. 5, the hidden command data value is 256 bits long, although any length may be used without departing from the scope of the present invention. In some embodiments, hidden command data value 510 is used to identify a memory write command as a hidden command. When a write command is received having data in the first 256 bits that match the hidden command data value, the command is identified as one to be diverted for purposes other than a memory write. As described above, a hidden command address value may be used in conjunction with, or instead of, a hidden command data value to form a hidden command value that identifies the memory write command as containing a hidden command.

The remaining fields have significance when the memory write includes a hidden command. For example, if the first 256 bits do not match the hidden command data value (or if the write address does not match the hidden command address value, or both) then the remaining bits in the data field are to be treated as data in a normal memory write command. In contrast, when the memory write is a hidden command, the remaining fields are used to further interpret the hidden command.

Command routing component 320 (FIG. 3) inspects the hidden command data value 510, status field 520, and possibly password field 530 and device ID 532. If the command is identified as a hidden command, command routing component 320 forwards the password 530, command index 540, and related data 550 to non-memory control component 330.

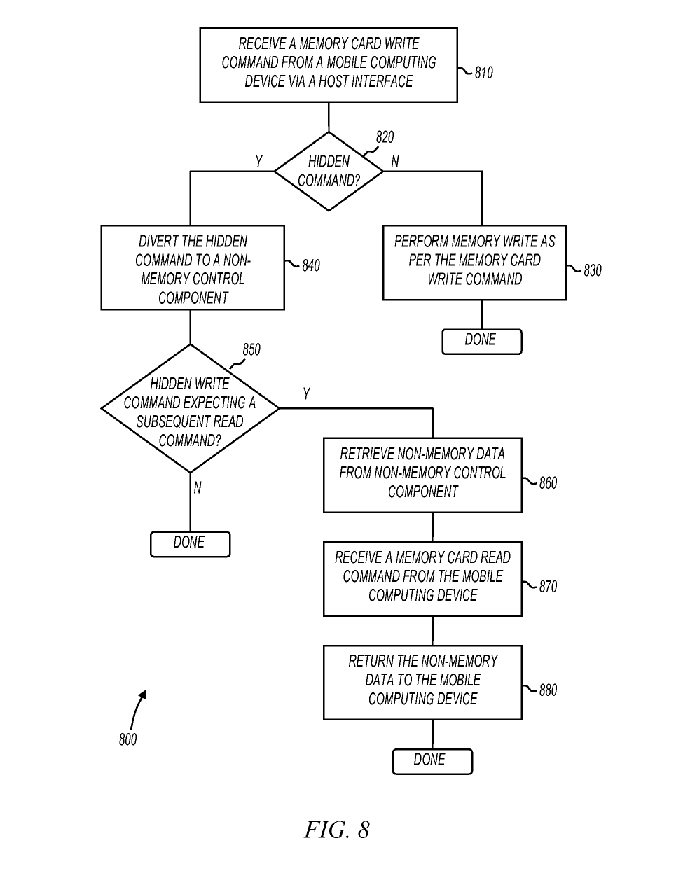

Status field 520 may include any information relating to the status of the hidden command. For example, status field 520 may include one more bits to signify to command routing component 320 whether the host (mobile computing device) is expecting the non-memory control component to return data in response to the hidden command. For example, when status field 520 signifies a write, command routing component 320 forwards the password device ID, command index, and related data without expecting to return any data to the host. Also for example, when status field 520 signifies a read, command routing component 320 forwards the password, device ID, command index, and related data with the expectation that non-memory control component 330 will provide data to be sent to the host in response to a memory card read command. The combination of a memory card write command followed shortly thereafter by a memory card read command may be used to provide “read” functionality to the non-memory control component. Read operations from the non-memory control component are described further below with reference to FIG. 8.

Password field 530 includes a password to allow non-memory control component 330 to authenticate the host to the token. In some embodiments, every hidden command includes a password. Each time the password, device ID, command index, and related data is diverted to the non-memory control component, the password is checked to authenticate the host to the token.

Device ID 532 uniquely identifies the host (mobile computing device). The device ID may be checked by the non-memory control component to ensure that the token is inserted in the host to which it is authenticated. Some embodiments of the present invention enforce a unique host/token pairing using the device ID, and other embodiments allow non-memory control functions to be accessed by any host.

Command index 540 identifies the type of hidden command. The number of possible hidden commands is limited only by the number of bits allocated thereto. Any number of bits may be allocated to command index 540 without departing from the scope of the present invention. Hidden command related data 550 may be utilized differently for each type of hidden command. Any number of bits may be used for hidden command related data 550.

The data shown in FIG. 5 is provided as an example, the data field of a memory card access command may include more or fewer data fields than those shown in FIG. 5. The present invention is not limited by the number or content of the fields in a memory card access command.

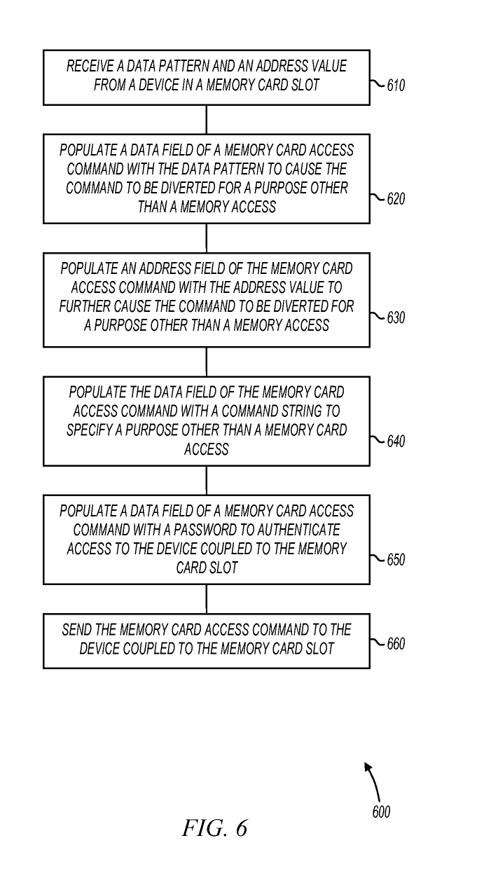

FIG. 6 shows a flowchart in accordance with various embodiments of the present invention. In some embodiments, method 600 may be used by a mobile computing device to communicate with a token in a memory card slot. In some embodiments, method 600, or portions thereof, is performed by a mobile computing device with a memory card slot, and in other embodiments, method 600, or portions thereof, is performed by software. The various actions in method 600 may be performed in the order presented, in a different order, or simultaneously. Further, in some embodiments, some actions listed in FIG. 6 are omitted from method 600.

Method 600 begins at 610 in which a data pattern and an address value are received from a device in a memory card slot. The data pattern corresponds to the hidden command data value, and the address value corresponds to the hidden command address value. In some embodiments, the mobile device only receives the data value and in other embodiments, the mobile device only receives the address value. In some embodiments, the actions of 610 may occur once when the device is first inserted in the memory card slot. The mobile computing device may then use the address and data values each time it creates a hidden command. In other embodiments, the actions of 610 may occur each time the device is inserted in the memory slot. In still further embodiments, the actions of 610 may occur periodically. Each time the actions 610 occur, the data pattern may be the same or different, and the address value may be the same or different.

At 620, a data field of a memory card access command is populated with the data pattern to cause the command to be diverted for a purpose other than a memory access. For example, the data pattern may be written to the data field as the hidden command data value 510 (FIG. 5).

At 630, an address field of the memory card access command is populated with the address value to further cause the command to be diverted for purposes other than a memory access. In some embodiments, only one of 620 or 630 is utilized. In these embodiments, the presence of a hidden command is signified by the data pattern alone, or the address value alone.

At 640, the data field of the memory card access command is populated with a command string to specify a purpose other than a memory card access. For example, the command string may be written to the data field as the command index 540 for the non-memory control component.

At 650, the data field of a memory card access command is populated with a password to authenticate access to the device coupled to the memory card slot. In some embodiments, a password is included in the data field for every hidden command. In other embodiments, a password is only included at the beginning of an exchange.

At 660, the memory card access command is sent to the device coupled to the memory card slot. For example, a mobile computing device (110, FIG. 1) may send the memory card access command to a token (120, FIG. 1) in a memory card slot (112, FIG. 1). The token may include a command routing component (320, FIG. 3) to divert the command based on the data fields populated in method 600.

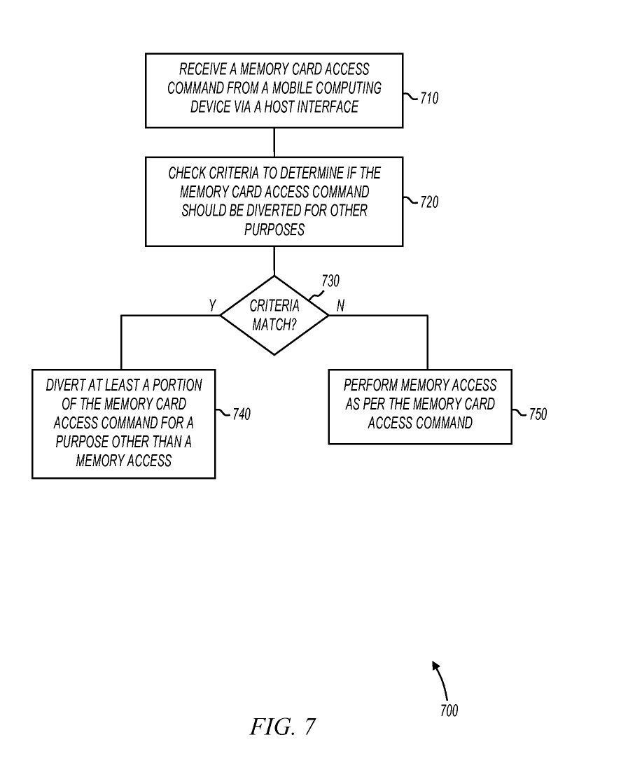

FIG. 7 shows a flowchart in accordance with various embodiments of the present invention. In some embodiments, method 700 may be used by token in a memory card slot. In some embodiments, method 700, or portions thereof, is performed by a command routing component within a token, and in other embodiments, method 700, or portions thereof, is performed by software. The various actions in method 700 may be performed in the order presented, in a different order, or simultaneously. Further, in some embodiments, some actions listed in FIG. 7 are omitted from method 700.

Method 700 begins at 710 in which a memory card access command is received from a mobile computing device via a host interface. The actions of 710 correspond to a token in a memory card slot of a mobile computing device receiving a memory card access command.

At 720, the token checks criteria in the memory card access command to determine if the memory card access command should be diverted for other purposes. The criteria may be one or both of a hidden command data value, a hidden command address value, or both. If there is a criteria match at 730, then a hidden command is present, and at least a portion of the memory card access command is diverted at 740. If there is not a criteria match, then no hidden command is present, and a memory access is performed at 750.

FIG. 8 shows a flowchart in accordance with various embodiments of the present invention. In some embodiments, method 800 may be used by token in a memory card slot. In some embodiments, method 800, or portions thereof, is performed by a command routing component within a token, and in other embodiments, method 800, or portions thereof, is performed by software. The various actions in method 800 may be performed in the order presented, in a different order, or simultaneously. Further, in some embodiments, some actions listed in FIG. 8 are omitted from method 800.

Method 800 begins at 810 in which a memory card write command is received from a mobile computing device via a host interface. If the memory card write command is determined to be a hidden command, processing continues with 840; otherwise, a memory write is performed at 830.

At 840, the hidden command is diverted to a non-memory control component. If the hidden command is determined to be a “read” at 850, processing continues at 860; otherwise, the hidden command processing is done. At 860, the command routing component retrieves non-memory data from the non-memory control component, and at 870, a memory card read command is received from the mobile computing device. At 880, the non-memory data is returned to the mobile computing device.

Method 800 demonstrates how a mobile computing device can perform a read from an optional function or from a non-memory control component. The mobile computing device issues a memory card write command with a hidden command having a status field designating a read, and then the mobile computing device issues a memory card read command. The processing in the card receives the hidden command, identifies it as a read, and then returns data to the mobile computing device in response to a subsequent memory card read command.

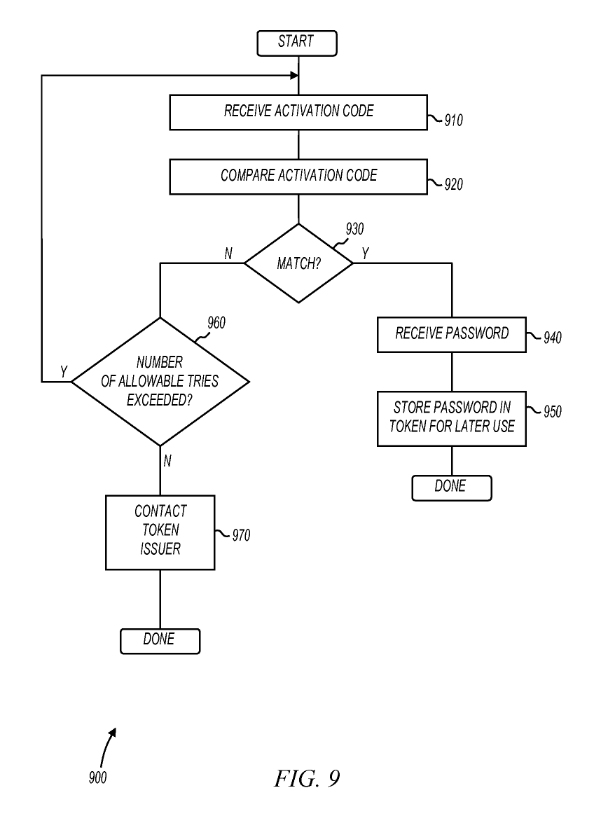

FIG. 9 shows a method authenticating a mobile computing device to one or more functions in a token. Method 900 begins at block 910 in which an activation code is received at a token from a mobile computing device. At 920, the received activation code is compared to a code stored in the token. If the activation code matches, the token receives a password from the mobile computing device at 940, and stores the password in the token for later use at 950. If the activation code does not match, the token determines whether a number of allowable tries has been exceeded at 960. If the number of allowable tries has been exceeded, the token issuer is contacted at 970, and if the number of allowable tries has not been exceeded, the method repeats until either the activation code matches or the number of allowable tries has been exceeded.

Method 900 may be performed when a token is issued to a user. The user may be provided an activation code to “activate” the token. When the user successfully enters the activation code, the user is prompted for a password, and that password is stored for use in future hidden commands.

In some embodiments, multiple non-memory functions in a token are authenticated using method 900. For example, each of multiple non-memory functions may have stored activation codes, and each is activated separately. Each of the separately activated functions may have a different password, or the multiple functions may share a password.

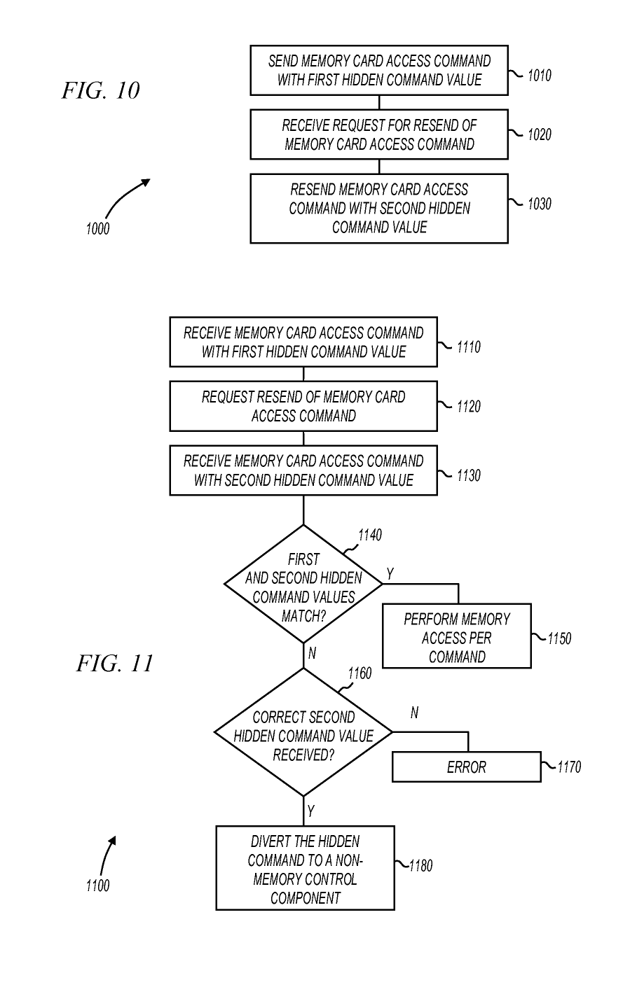

FIG. 10 shows a flowchart in accordance with various embodiments of the present invention. In some embodiments, method 1000 may be used by a mobile computing device to communicate with a token in a memory card slot. In some embodiments, method 1000, or portions thereof, is performed by a mobile computing device with a memory card slot, and in other embodiments, method 1000, or portions thereof, is performed by a processor executing software instructions. The various actions in method 1000 may be performed in the order presented, in a different order, or simultaneously. Further, in some embodiments, some actions listed in FIG. 10 are omitted from method 1000.

Method 1000 begins at 1010 in which a memory card access command is sent to a token in a memory card slot. The memory card access command includes a first hidden command value to signify the presence of a hidden command in the memory card access command. In some embodiments, this corresponds to hidden command data value 510 (FIG. 5) being set to a first hidden command value. The first hidden command value may be a common value or a unique value.

At 1020, a request to resend the memory card access command is received, and at 1030, the memory card access command is sent with a second hidden command value. The second hidden command value is different from the first hidden command value. Both the mobile device and the token know the correct values for the first and second hidden command values. In order for the token to interpret the presence of a hidden command in the memory card access command, both the first and second hidden command values must be correct. By utilizing multiple hidden command values in this fashion, the likelihood of a memory card access command being mistakenly interpreted as including a hidden command is drastically reduced. Only when the mobile device and the token are aware of the correct sequencing of hidden command values will the memory card access command be interpreted as including a hidden command.

FIG. 11 shows a flowchart in accordance with various embodiments of the present invention. In some embodiments, method 1100 may be used by token in a memory card slot. In some embodiments, method 1100, or portions thereof, is performed by a command routing component within a token, and in other embodiments, method 1100, or portions thereof, is performed by a process executing software instructions. The various actions in method 1100 may be performed in the order presented, in a different order, or simultaneously. Further, in some embodiments, some actions listed in FIG. 11 are omitted from method 1100.

Method 1100 begins at 1110 in which a memory card access command with a first hidden command value is received from a mobile computing device via a host interface. The actions of 1110 correspond to a token in a memory card slot of a mobile computing device receiving a memory card access command sent at 1010 (FIG. 10).

At 1120, the token requests a resend of the memory card access command. The actions of 1120 correspond to sending the request received at the mobile device at 1020 (FIG. 10).

At 1130, the token receives the memory card access command that was resent. The memory card access command is received with a second hidden command value. The actions of 1130 correspond to a token in a memory card slot of a mobile computing device receiving a memory card access command sent at 1030 (FIG. 10).

At 1140, the token determines if the first and second hidden command values match. If they do match, then the memory card access command is not treated as including a hidden command, and a memory access is performed per the received command at 1150. If the first and second hidden commands do not match, then the second hidden command value is further scrutinized at 1160.

At 1160, the token determines if the correct second hidden command value has been received in order to treat the memory access command as including a hidden command. If the correct value is received, then the hidden command is diverted to a non-memory control component at 1180. Otherwise, error processing is performed at 1170.

The relationship between the first and second hidden command values in methods 1000 and 1100 may be defined in any manner. For example, in some embodiment, a mathematical relationship exists between the two hidden command values. In these embodiments, both the mobile device and the token know the mathematical function to apply to the first hidden command value to arrive at the second hidden command value. In other embodiments, a predefined sequence of hidden command values exists, and both the mobile device and the token have knowledge of the predefined sequence.

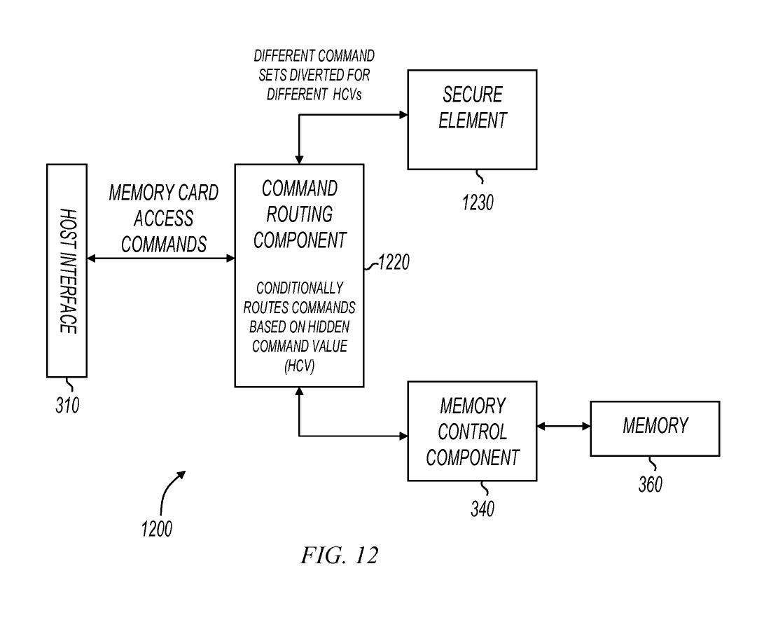

FIG. 12 shows a block diagram of a token with a secure element that is accessed using hidden commands. Token 1200 includes host interface 310, command routing component 1220, memory control component 340, memory 360, and secure element 1230. The term “secure element” as used herein refers to any type of secure controller such as a smart card controller, a subscriber identity module (SIM) controller, a universal integrated circuit card (UICC) controller, a universal subscriber identity module (USIM) controller, a controller meant to be embedded in an intelligent electronic device, or any equivalents or derivatives therof. Token 1200 may be any type of token capable of communicating with a memory card slot in a mobile computing device. Further, token 1200 may take any form factor compatible with a memory card slot. Host interface 310, memory control component 340, and memory 360 are described above with reference to previous figures.

Secure element 1230 is an optional function within token 1200. As described further below, secure element 1230 may be accessed by a mobile computing device by sending hidden commands within a memory card access command. In some embodiments, secure element 1230 may securely store information. For example, secure element 1230 may exchange encrypted communications with a mobile device via command routing component 1220 and host interface 310. Any type of encryption may be employed, and the corresponding encryption keys may be known by the secure element a second party. The second party may include software running on the mobile device, or may be a trusted third party with which the mobile device communicates.

In some embodiments, secure element 1230 may be a smart card controller that includes a secure element or functions as a secure element. Examples of smartcard controllers are the “SmartMX” controllers sold by NXP Semiconductors N.V. of Eindhoven, The Netherlands. In some embodiments, secure element 1230 has an ISO/IEC 7816 compatible interface that communicates with command routing component 1220, although this is not a limitation of the present invention.

Command routing component 1220 functions to route memory card access commands received from host interface 310. Commands may be routed to memory control component 340 for memory accesses, or may be routed (diverted) to secure element 1230 for purposes other than memory accesses. For example, when token 1200 is communicating with a memory card slot in a mobile computing device, the mobile computing device may send a memory card access command in order to access memory 360. Also for example, the mobile computing device may send a memory card access command that contains a hidden command value and a hidden command. Command routing component 1220 detects the presence of the hidden command, and routes the hidden command to secure element 1230.

Command routing component 1220 may recognize more than one hidden command value for secure element 1230. For example, command routing component 1220 may recognize one or more common hidden command values, and one or more unique hidden command values. In some embodiments, different hidden commands are either blocked or diverted to secure element 1230 based on the hidden command value present in the memory access command. In general, any subset of all possible hidden commands may be mapped to any hidden command value.

In some embodiments, a fixed hidden command value may be common to all secure elements, and all tokens may allow a subset of all possible hidden secure element commands when a common hidden command value is recognized. For example, all tokens may allow simple queries such as a request for a secure element chip serial number (CSN) using a common hidden command value. Also for example, all tokens may block access to more sensitive information (such as financial information stored in the secure element) when a common hidden command value is recognized.

In some embodiments, one or more hidden command values may be unique to a particular secure element, and different subsets of all possible hidden secure element commands are allowed for each of the unique hidden command values. Command routing component 1220 may recognize any number of common, unique, and/or dynamic hidden command values, and may allow any number of subsets of all possible hidden secure element commands based on these hidden command values.

In various embodiments of the invention, command routing component 1220 may be implemented in many different ways. For example, in some embodiments, the various components are implemented in hardware. In these embodiments, the various components may be implemented as separate integrated circuits, or in a combined integrated circuit. Also for example, in some embodiments, the various components may be implemented in software, or in a combination of hardware and software. In some embodiments, command routing component 1220 may include a microprocessor, and the various functions performed by command routing component 1220 may be implemented as software modules running on the microprocessor.

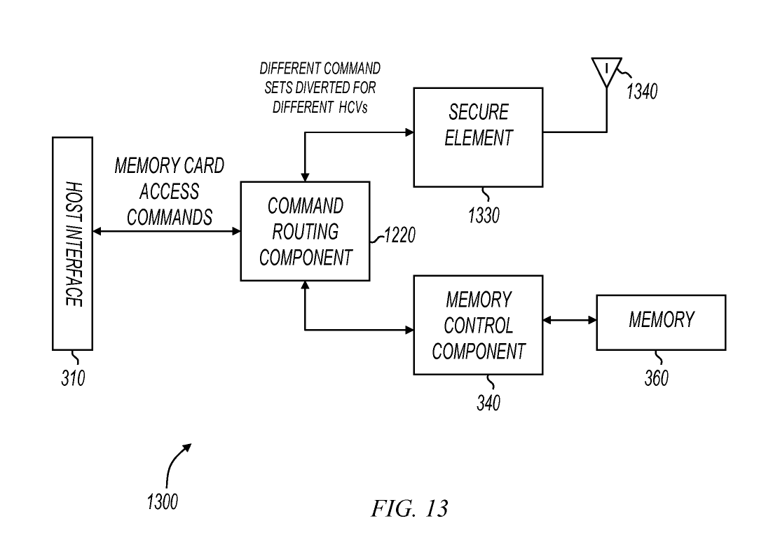

FIG. 13 shows a block diagram of a token with a secure element that is accessed using hidden commands. Token 1300 includes host interface 310, command routing component 1220, memory control component 340, memory 360, secure element 1330, and antenna 1340. Token 1300 may be any type of token capable of communicating with a memory card slot in a mobile computing device. Further, token 1300 may take any form factor compatible with a memory card slot. Host interface 310, command routing component 1220, memory control component 340, and memory 360 are described above with reference to previous figures.

Secure element 1330 is an optional function within token 1300. Secure element 1330 provides the same functions as secure element 1230 (FIG. 12), and also includes a contactless interface coupled to antenna 1340. In some embodiments, the contactless interface complies with ISO/IEC 14443A. For example, in some embodiments, secure element 1330 is a dual interface smartcard controller with both an ISO/IEC 7816 contact interface and an ISO/IEC 14443A contactless interface.

Antenna 1340 may be any type of antenna compatible with secure element 1340. Examples include a coil wound about a magnetic core, a coil formed on a circuit board, or the like.

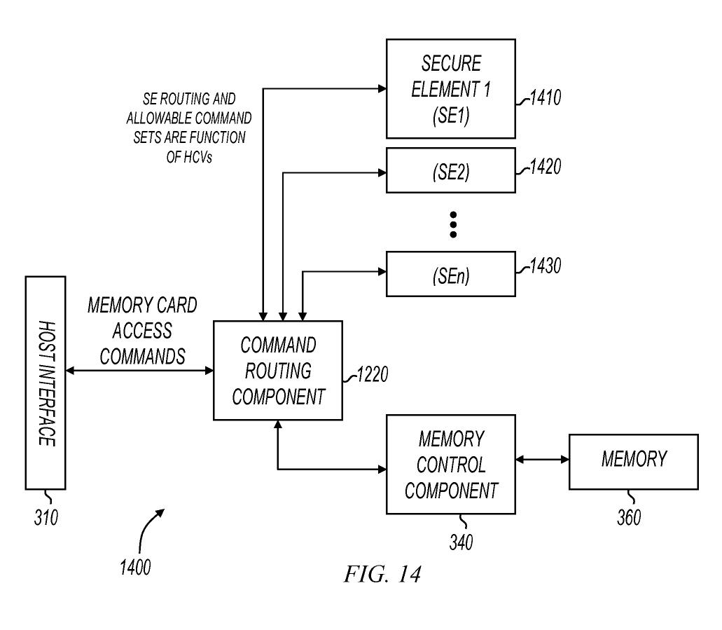

FIG. 14 shows a block diagram of a token with multiple secure elements that are accessed using hidden commands. Token 1400 includes host interface 310, command routing component 1220, memory control component 340, memory 360, and secure elements 1410, 1420, and 1430. Token 1400 may be any type of token capable of communicating with a memory card slot in a mobile computing device. Further, token 1400 may take any form factor compatible with a memory card slot. Host interface 310, command routing component 1220, memory control component 340, and memory 360 are described above with reference to previous figures.

In operation, command routing component 1220 routes hidden commands to one or more of secure elements 1410, 1420, and 1430 based on the hidden command value present in memory card access commands. In some embodiments, keys to each secure element are separately owned and managed by different entities. For example, a first credit card brand may control encryption keys for secure element 1410, while a second credit card brand may control encryption keys for secure element 1420. Multiple secure elements and a command routing component may allow multiple payment applications representing multiple brands and/or banks to coexist on one token. Also for example, a government entity may own and/or manage encryption keys for secure element 1410, while a financial institution may own/or manage encryption keys for secure element 1420. This may allow identity applications to coexist with financial applications. Encryption keys for multiple secure elements on a single token may be managed in any manner without departing from the scope of the present invention.

Command routing component 1220 may route hidden commands to different secure elements based on hidden command values, or the combination of hidden command values and the hidden commands themselves. For example, a common hidden command value may be used to fetch a chip serial number (CSN) for each secure element. Also for example, hidden command values unique to each secure element may be used to load financial data into each secure element separately. In general, any subset of all possible secure element commands may be routed to any secure element based on hidden command values.

In some embodiments, one or more of secure elements 1410, 1420, and 1430 are dual interface smartcard controllers, and one or more antennas exist on token 1400. Further, any number of secure elements may exist on token 1400 without departing from the scope of the present invention.

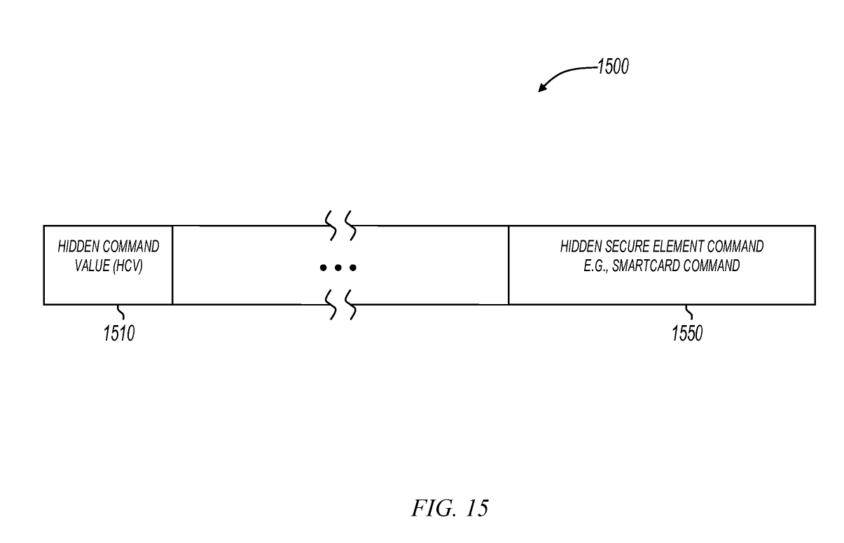

FIG. 15 shows a portion of a memory card access command in accordance with various embodiments of the present invention. Memory card access command 1500 includes hidden command value (HCV) 1510 and hidden secure element command 1550. As described above, HCV 1510 may include an address field, a data field, or any combination. Hidden secure element command 1550 may be any type of command destined for a secure element. For example, hidden secure element command 1550 may be a smartcard command that can be interpreted by a smartcard controller. Hidden secure element command 1550 may also be a combination of instructions or responses, including any associated data values, address values, or other values, being sent to or being received from a secure element.

When memory card access command 1500 is interpreted by a command routing component such as command routing component 1220, hidden secure element command 1550 is conditionally routed to one or more secure elements. For example, HCV 1510 may be a common HCV, and hidden secure element command 1550 may be routed to one or more secure elements. Also for example, HCV 1510 may be a unique HCV, and hidden secure element command 1550 may be routed to a secure element that is specific to that unique HCV.

Memory card access command 1500 may include many more fields without departing from the scope of the present invention. For example, any of the fields shown in FIG. 5 may be included, or any fields beyond those shown in FIG. 5 may be included.

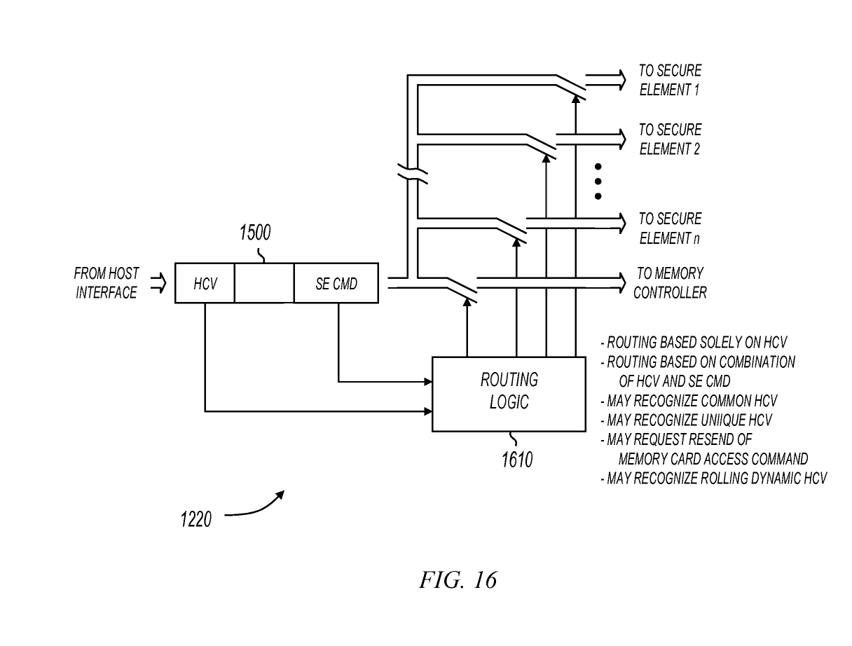

FIG. 16 shows a logical diagram of a command routing component. Command routing component 1220 receives a memory card access command shown at 1500. Only the HCV and secure element command (SE CMD) are shown in the memory card access command, however many more fields may be present.

Routing logic 1610 interprets the HCV to determine whether a hidden command exists. In some embodiments, command routing component 1220 requests a resend of the memory card access command and then interprets the HCV in the resent command in accordance with methods described with reference to FIGS. 10-11. If routing logic 1610 determines that a hidden command is not present, then the memory card access command is sent to the memory controller. If routing logic 1610 determines that a hidden command is present, then the SE CMD is conditionally routed to one or more secure elements.

In some embodiments, the routing is based solely on the HCV. In other embodiments, the routing is based on the combination of the HCV and SE CMD. This allows any subset of possible secure element commands to be routed to any secure element based on the hidden command value.

Routing logic 1610 may be implemented in any manner without departing from the scope of the present invention. For example, routing logic 1610 may be implemented as a processor with memory. The memory may hold instructions that when accessed result in the processor performing the routing as described. The memory may also store a table that specifies the relationship between HCVs, SE CMDs, and secure elements. Also for example, routing logic 1610 may be implemented as a state machine in hardware. Further, as described below, the functionality of routing logic 1610 may be incorporated in a memory card controller.

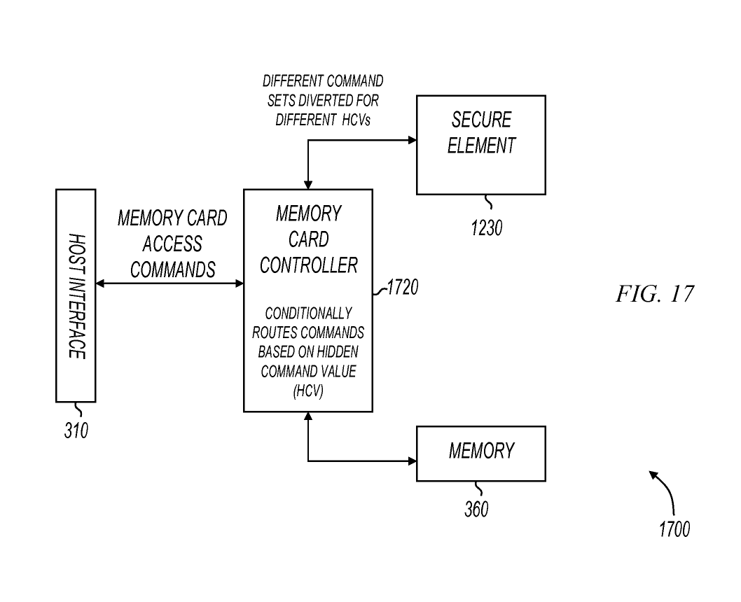

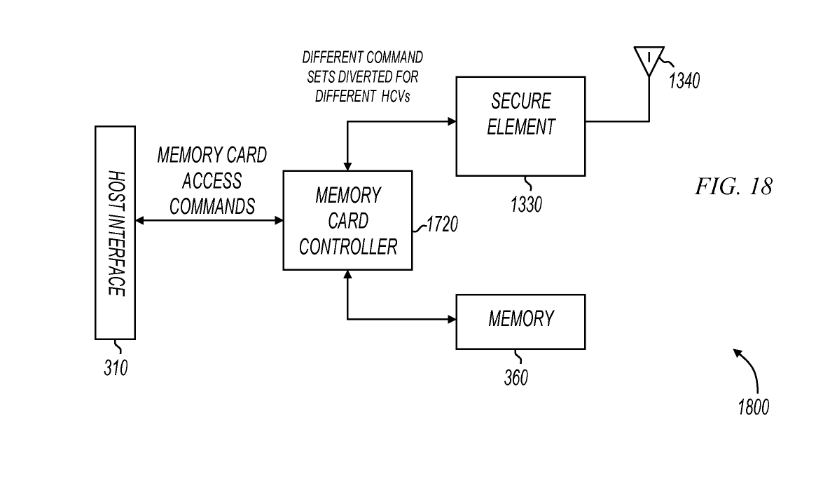

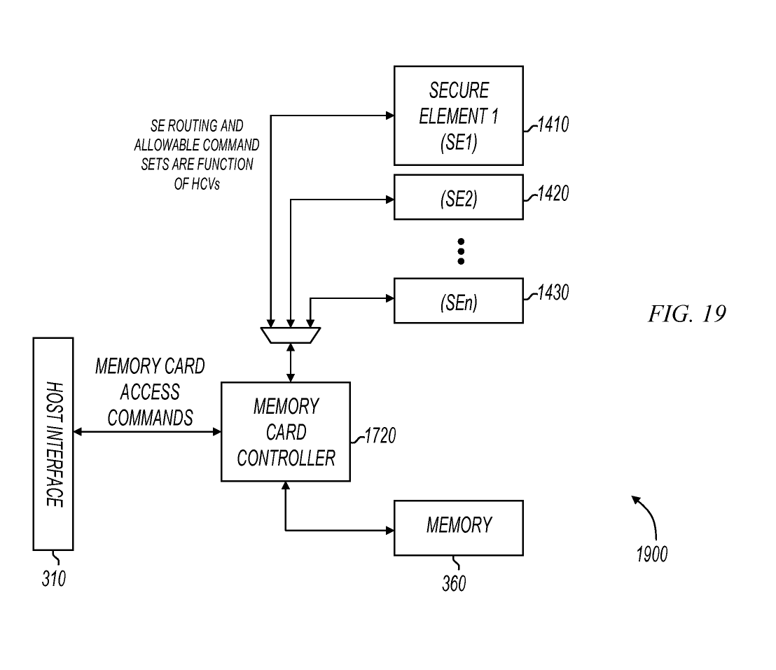

FIGS. 17-19 show tokens in accordance with various embodiments of the present invention. Tokens 1700, 1800, and 1900 (FIGS. 17-19) correspond to tokens 1200, 1300, and 1400 (FIGS. 12-14), respectively, with the functions of the command routing component and memory control component being performed by memory card controller 1720.

In embodiments represented by FIGS. 17-19, memory card controller 1720 communicates with the mobile device using memory card access commands. Memory card controller 1720 also communicates with memory 360 and one or more secure elements. Memory card controller 1720 determines whether each command should result in a memory operation with memory 360, or whether the command should be diverted to one or more secure elements based on the HCV and the hidden command. In some embodiments, memory card controller 1720 executes instructions that are stored in an internal memory or stored in memory 360. In some embodiments, memory card controller 1720 includes special purpose hardware useful to determine whether a command should be diverted. In other embodiments, memory card controller 1720 may be a microcontroller identical in all respects to a controller found in memory cards, except for the program that it executes.

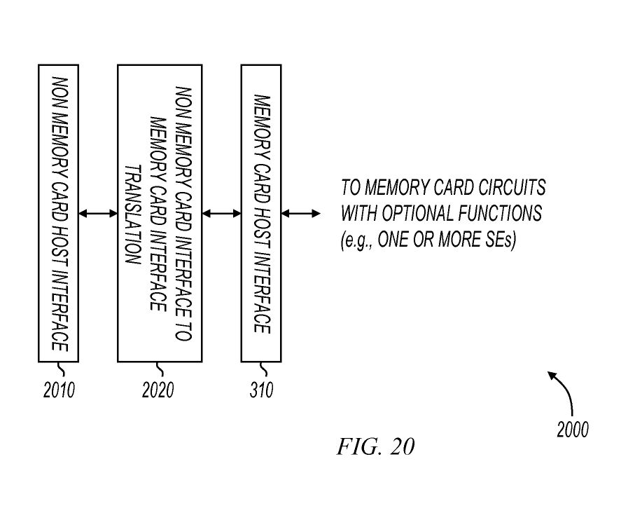

FIG. 20 shows an adapter that preserves hidden commands during a translation from a non-memory card interface to a memory card interface. Adapter 2000 includes non-memory card host interface 2010, memory card host interface 310, and non-memory card interface to memory card interface translation layer 2020. In some embodiments, adapter 2000 physically receives a memory card. For example, adapter 2000 may be a universal serial bus (USB) card reader that physically accepts a microSD memory card.

In operation, non-memory card host interface 2010 receives a command from a mobile device. The command includes an encapsulated memory card access command. Non-memory card interface to memory card interface translation layer 2020 translates the non-memory card command to a memory card command, and provides the memory card command to memory card host interface 310. At this point, the memory card command is interpreted as described above. If a hidden command exists in the memory card command, then it is diverted to an optional function, which in some embodiments, includes one or more secure elements.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A memory card comprising:
a host interface;
a secure element; and
a command routing component to receive a memory access command from the host interface and to conditionally route at least a portion of the memory access command to the secure element based on a hidden command value within the memory access command.

2. The memory card of claim 1 wherein the portion of the memory access command includes a smartcard command.

3. The memory card of claim 2 wherein the command routing component conditionally routes based on both the hidden command value and the smartcard command.

4. The memory card of claim 1 further comprising a plurality of secure elements coupled to the command routing component.

5. The memory card of claim 5 wherein the command routing component routes the portion of the memory access command to different secure elements based on the hidden command value.

6. The memory card of claim 1 wherein the secure element includes an ISO/IEC 7816 contact interface coupled to the command routing component.

7. The memory card of claim 6 wherein the secure element further includes an ISO/IEC 14443A contactless interface.

8. The memory card of claim 1 wherein the secure element comprises a dual interface smartcard controller.

9. The memory card of claim 1 wherein the command routing component comprises a memory card controller.

10. An apparatus comprising:
a memory card having a secure element and a command routing component coupled to the secure element;
wherein the command routing component is operable to detect a hidden command value and a secure element command in a memory access command received at the memory card, and to route a subset of all possible secure element commands to the secure element based on the hidden command value.

11. The apparatus of claim 10 further comprising a plurality of secure elements coupled to the command routing component.

12. The apparatus of claim 10 wherein the command routing component is operable to route a first subset of secure element commands to the secure element when the hidden command value matches a common value for all secure elements.

13. The apparatus of claim 10 wherein the command routing component is operable to route a second subset of secure element commands to the secure element when the hidden command value matches a value unique to the secure element.

14. The apparatus of claim 10 wherein the command routing component is operable to recognize a hidden command value that rolls to different values.

15. The apparatus of claim 10 further comprising an adapter to translate commands from a non-memory card format to a memory card format.

16. The apparatus of claim 15 wherein the adapter comprises a universal serial bus to microSD adapter.

17. A method comprising:
receiving a first memory card access command;
detecting a first hidden command value in the first memory card access command;
requesting a resend of the first memory card access command;
receiving the resent first memory card access command as a second memory card access command;
detecting a second hidden command value in the second memory card access command; and
routing a secure element command embedded in the second memory card access command to a secure element.

18. The method of claim 17 wherein the secure element comprises a smartcard controller, and wherein routing the secure element command comprises routing a smartcard command.

19. A method comprising:
embedding a secure element command and a first hidden command value in a first memory card access command;
sending the first memory card access command to a memory card that includes a secure element;
receiving a request to resend the first memory card access command;
embedding a second hidden command value in a second memory card access command; and
sending the second memory card access command to the memory card.

20. The method of claim 19 wherein embedding a secure element command in a first memory card access command comprises embedding a smartcard command.
